(19) United States
(12) Patent Application Publication
(10) Pub. No.: US 2008/0046320 A1
(43) Pub. Date: Feb. 21, 2008

(54) Systems, apparatuses and methods for identifying reference content and providing proactive advertising

(76) Inventors: Lorant Farkas, Budapaest (HU); Szabolcs Fodor, Budapest (HU)

Correspondence Address: Hollingsworth & Funk, LLC;Suite 125, 8009 34th Avenue South, Minneapolis, MN, 55425, US

(21) Appl. No.: 11/804,874

(22) Filed: May 21, 2007

Related U.S. Application Data
(60) Provisional application No. 60/818,155, filed on Jun. 30, 2006.

(51) Int. Cl. G06Q 30/00

(52) U.S. Cl. 705/14

(57) ABSTRACT

Systems, apparatuses and methods for identifying company content and facilitating advertising in response. The company or other entity can provide reference media to devices, which is stored at the device(s). Media occurring within a vicinity of the device is recorded by the device. The recorded media is compared to the reference media to identify any matching media, and information pertaining to matching occurrences of the recorded media and the reference media is transmitted. A designated server system or local system provides a company database that can receive the information, and in response may provide links for association with the device-recorded media. In this manner, the devices gather media and ultimately obtain links to the company(s) associated with the recorded media.

### RELATED APPLICATIONS

This application claims the benefit of U.S. Provisional Application No. 60/818,155 filed Jun. 30, 2006, the content of which is incorporated herein by reference in its entirety.

### FIELD OF THE INVENTION

This invention relates in general to communications and advertising, and more particularly to apparatuses and methods for identifying company occurrences within a vicinity of communication devices, and facilitating advertising and other notifications in response thereto.

### BACKGROUND OF THE INVENTION

Mobile devices generally refer to handheld or otherwise portable devices that can communicate via networks over-the-air (OTA). Mobile phones, personal digital assistants and the like are representative of today's mobile devices. Technological advances in the devices, protocols, and networks have contributed to the increase in functionality of these devices. Where early mobile phones were largely limited to conducting voice communications, today's mobile devices provide a broad range of useful functions. These functions include, for example, voice communications, data communications, Internet access, e-mail and text/multimedia messaging, calendaring and contact functions, games, camera and video functions, short-range and ad-hoc networking capabilities, etc. Mobile phones that include these types of functions are often referred to as “smart phones.” While what constitutes a “smart phone” is somewhat nebulous, mobile devices that at least allow data to be communicated will be referred to as smart phones for purposes of the description provided herein.

Many of these mobile devices can input and output text and graphics, as well as record and playback audio and video. These devices often include contextual information, such as the user's and/or device's location, state of mind, etc. Smart phones and other mobile devices are increasingly acquiring the potential to record diverse and large quantities of data, which can include data such as audio, video, text, contextual information, etc. Today, these functions are largely used only for the benefit of the user of the device.

Companies have increasing difficulties in establishing channels towards consumers to advertise their products and services. Radio and television advertisements continually need to contrive sometimes radical approaches to be able to exceed the user attention threshold needed to cross the short/long-term memory boundary of the particular person, and thus to make the message be sufficiently perceived and remembered. Today's advertising methodologies thus lack in their ability to stay in the mind of the consumer, without being overly invasive. Further, it is difficult to provide advertisements to users of mobile devices, particularly without bombarding the user with a plethora of unwanted or unsolicited information.

Accordingly, there is a need for a manner of providing additional, and effective advertising channels. A further need exists to provide such advertising channels to mobile device users. The present invention fulfills these and other needs, and offers numerous advantages over prior art approaches.

### SUMMARY

To overcome limitations in the prior art described above, and to overcome other limitations that will become apparent upon reading and understanding the present specification, the present invention discloses apparatuses and methods for identifying company occurrences within a vicinity of communication devices, and facilitating advertising and other notifications in response thereto.

In accordance with one embodiment of the invention, a method is provided which involves storing reference media at a device and recording media occurring within a vicinity of the device. The recorded media is compared to the reference media at the device, and information pertaining to matching occurrences of the recorded media and the reference media is transmitted from the device.

According to more particular embodiments of such a method, results of the matching occurrences of the recorded media and the reference media may be ranked as a function of their frequency of occurrence. These results may be transmitted from the device to an entity(s) associated with the results.

One embodiment of such a method further includes receiving a link(s) associated with the matching occurrences of the recorded media and the reference media. In a different embodiment, the method includes providing context information of the device, and receiving context-specific information in response to transmitting the information pertaining to matching occurrences of the recorded media and the reference media.

In one embodiment, a network element receives the information pertaining to matching occurrences of the recorded media and the reference media, and records the information in a database. In another embodiment, the information is stored in a database local to the device rather than external to the device. In one particular embodiment, one or more links are associated with the recorded content that matched the reference media.

According to another embodiment, the method further involves the device transmitting a set of the information pertaining to matching occurrences of the recorded media and the reference media occurring over a period of time. In one embodiment, payment may be received for providing the set of the information.

In one embodiment, the information pertaining to matching occurrences includes the matching media itself, while in another embodiment the information includes a count of the number of matches that occur.

The media (including a portion thereof) may be recorded continuously, or at one or more of particular times and in response to particular events. Further, the reference media may be received from one or more different entities.

In accordance with another embodiment of the invention, a method is provided where reference media is provided to a device. Information pertaining to matching occurrences of device-recorded media and the reference media is received. In response, one or more links are provided for association with the device-recorded media.

According to more particular embodiments, the method may further involve creating an entry in a database corresponding to the received information. In another embodiment the method includes receiving context information associated with the device, where providing links involves providing context-specific links based on the context information associated with the device.

In one embodiment, the method involves subscribing to receive a set of information corresponding to the matching occurrences of device-recorded media and the reference media occurring over a period of time. In another embodiment, the method includes recording a count of the information received that pertains to matching occurrences of device-recorded media and the reference media. In yet another embodiment, a replacement link(s) is provided to update the links associated with the device-recorded media.

In accordance with another embodiment of the invention, an apparatus is provided which includes one or more media gathering devices to obtain external media at the apparatus. A memory stores reference media and the external media. A compare module compares the external media to the reference media, and identifies matching occurrences of the external media and the reference media. A transmitting module is configured to locally or externally transmit information pertaining to the identified matching occurrences of the external media to the reference media.

In more particular embodiments, the apparatus includes a ranking module coupled to the compare module and configured to rank a the identified matching occurrences as a function of their frequency of occurrence.

One embodiment involves media gathering devices that involves media capturing devices configured to capture media within a vicinity of the apparatus. By way of example and not of limitation, such capturing devices include a camera, video recorder, audio recorder, etc. In another embodiment, the media gathering devices include one or more content receiving modules configured to receive media transmitted to the apparatus. By way of example and not of limitation, such content receiving modules include any of a short message service module, a multimedia messaging service module, an e-mail module, an instant messaging module, a really simple syndication reader, a browser module, and a podcast module.

According to another embodiment, the apparatus includes a user interface to present one or more links received in response to transmitting the information pertaining to the identified matching occurrences of the external media to the reference media.

In another embodiment, the user interface is configured to initiate a request for transmission to a destination corresponding to at least one of the received links, wherein the request includes context information. The apparatus may include one or more sensors to ascertain information for use as at least part of the context information. The apparatus may instead or additionally include one or more position systems to identify an approximate location of the apparatus for use as at least part of the context information. The apparatus may instead or additionally include one or more of profile information, user information and device information forms at least part of the context information.

According to one embodiment, the apparatus further includes a processing system and a life data module executable on the processing system, where the processing system is configured to execute the life data module to provide stored data regarding the frequency of occurrence of the identified matching occurrences in a vicinity of the apparatus.

In accordance with another embodiment, a server is provided that includes a transmitting module configured to transmit reference media for use by at least one device, and a receiving module configured to receive information pertaining to matching occurrences of the reference media and media obtained by the device. A database is provided to store at least links. A processing system is configured to direct the transmitting module to send one or more of the links, identified by the matching occurrences received, for association with the media obtained by the device.

According to more particular embodiments of such a server, the database may be configured to further store the media obtained by the device that and received via the receiving module. In another embodiment, the processing system is further configured to modify one or more of the links to be sent based on context information received from the device. In yet another embodiment, the server further includes a link association module executable by the processing system to associate the links to be sent with the media obtained by the device.

In accordance with another embodiment of the invention, a computer-readable medium is provided which includes instructions executable by a computing system for identifying occurrences of reference media. The instructions cause the computing system to store reference media at a device, record media occurring within a vicinity of the device, compare the recorded media to the reference media at the device, and transmit from the device information pertaining to matching occurrences of the recorded media and the reference media.

In accordance with another embodiment of the invention, a computer-readable medium is provided which includes instructions executable by a computing system for facilitating advertising. The instructions cause the computing system to provide reference media to a device, receive information pertaining to matching occurrences of device-recorded media and the reference media, and provide one or more links for association with the device recorded media in response to receiving the information.

These and various other features of novelty which characterize the invention are pointed out with particularity in the claims annexed hereto and form a part hereof. However, to facilitate an understanding of the invention, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a representative embodiment of the invention where a mobile device gathers data and stores the information in a company database;

FIG. 2A is a flow diagram illustrating a representative manner in which a device identifies matching recorded and reference data;

FIG. 2B is a flow diagram illustrating a representative manner in which a network element, such as a company server/database, provides links in response to receiving information identifying an occurrence(s) of a company event;

FIG. 3 is a diagram illustrating a representative embodiment of system for providing personalized advertisements to mobile users and generating feedback to advertising sources;

FIG. 4 is a flow diagram illustrating an exemplary method in accordance with one embodiment of the present invention, where “life data” is provided to the company(s);

FIG. 5 is a block diagram illustrating a process of matching content with company brand information, where companies provide updated brand elements to which the match can be performed;

FIG. 6 illustrates a signal flow diagram of a representative embodiment of an advertisement feedback service;

FIG. 7 illustrates one representative process for updating links provided by the company;

FIG. 8 illustrates representative examples of the presentation of links and the personalization of content; and

FIG. 9 illustrates a representative system in which the present invention may be implemented or otherwise utilized.

### DETAILED DESCRIPTION OF EMBODIMENTS OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides systems, apparatuses and methods for identifying company occurrences within a vicinity of communication devices, and facilitating advertising and other notifications in response thereto. One aspect of the invention facilitates proactive advertisement and feedback by utilizing, for example, file metadata information stored in the user's personal mobile communication device. The invention utilizes the devices themselves to facilitate effective advertising channels to these very devices as well as other devices. The context of the device may be considered to provide personalized advertisements to users, while providing statistical and/or efficiency-related feedback to the companies or other entities through examination of recorded user data.

As previously indicated, mobile devices available today and in the future can/will input and output text and graphics, record and playback audio and video, handle contextual information, etc. Smart phones (which includes PDAs and other such mobile devices) are increasingly acquiring the potential to record diverse and large quantities of data, which can include data such as audio, video, text, contextual information, etc. When users have recorded this large database of information, new use cases can emerge on top of this huge database. This recorded data can be thought of as a new kind of media, as users will likely consume this data. Further, if recorded data (e.g., images, video, audio, text, context, etc.) contains company names and/or events with a certain frequency of occurrence, this information can be combined into a meta-database on top of which advertisement-related actions can be implemented.

Companies have increasing difficulties in establishing channels towards the users to advertise their products and services. However, the mobile devices of tomorrow will be able to store a huge amount of data—in fact up to a lifetime's worth of data. The recorded content may be used for various purposes, limited only by the collective creativity of the users. The content recorded by a mobile phone, PDA or other “smart phone” type of mobile device will be consumed and can be thought of as an alternative media that provides advertisement opportunities for companies. One aspect of the present invention relates to manners in which companies can exploit this advertisement opportunity for media content recorded by such mobile devices (and also non-mobile terminals such as desktop computers, workstations, etc.).

Companies are therefore provided with another channel to market their products, services, items and the like to potential consumers. In addition, a service model can be created in which companies would pay for their names, trademarks, brands, or other company-related information to be recorded in the association database. An alternative service model can be created in which companies pay for users to provide automatic feedback regarding the penetration of their advertisements through the individually recorded company databases, where the companies can get a measure of the efficiency of their advertising campaign.

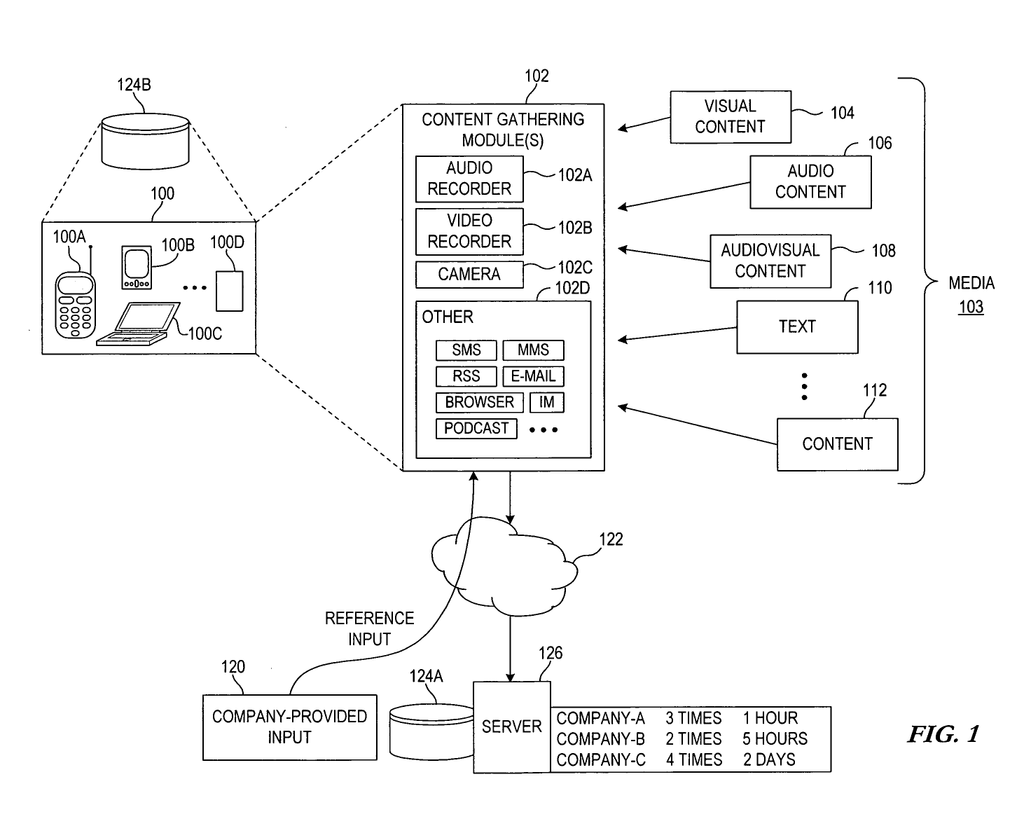

FIG. 1 is a block diagram illustrating one embodiment of the invention where a mobile device gathers data and stores the information in a company database. In this embodiment, the mobile device 100 represents any mobile device capable of gathering/obtaining one or more types of media, and transmitting information in response to gathering the media. The representative mobile device 100 of FIG. 1 includes, for example, a mobile phone or smart phone 100A, personal digital assistant 100B, portable computing device 100C, or other such communication device 100D.

The mobile device 100 searches for “company content” in terms of encountered words, audio, images, video, etc. The device 100 searches by gathering information via one or more content gathering modules 102. In the illustrated embodiment, the content gathering modules 102 include an audio recorder 102A, video recorder 102B, camera 102C and/or other 102D device to record any type of perceivable media 103. Representative types of media 103 includes, but is not limited to, visual content 104, audio content 106, audiovisual content 108, text 110 and/or other content 112. The content that is gathered is the content that is within a vicinity, e.g., a perceivable range, of the device 100, or at least within a perceivable range of the respective content gathering module 102 that is to record the respective media. For example, a perceivable range for an audio signal is the range where a microphone or other audio sensing device can substantially perceive the audio signal to the point that it can be recognized for what it is.

Other content gathering modules, shown as block 102D of the content gathering modules 102, may include modules that receive the content via communications or other transmission rather than by capturing the content. As an example, the content may be received by way of incoming messaging traffic such as, for example, e-mail, short message service (SMS), multimedia messaging service (MMS), instant messaging (IM) and/or any other similar manner of communicating messages. As another example, the content may be received by way of incoming HTTP (or analogous) traffic such as, for example, via a browser, really simple syndication (RSS) reader, podcasting application and the like. For purposes of the description provided herein, all such types of modules are referred to as content gathering modules 102.

Examples of visual content 104 includes a viewable name of a company, such as a brand name, company name or other company indicia that can be viewed and recorded by, for example, the camera 102C, video recorder 102B, etc. An example of audio content 106 includes the name/brand of the company or product stated verbally. Other examples include sounds associated with the company, such as marketing jingles, company-specific sounds such as ringtones, etc. Video and/or audiovisual content 108 may include, for example, company-specific actions or animations. Text 110 may include received text, such as being transmitted to the mobile device 102 (e.g., Bluetooth, infrared, or any other manner of receiving transmitted text), or may be derived from visual/audiovisual content using technologies such as digital character recognition, optical character recognition (OCR), or the like. These are merely examples of the types of media 103, and types of gathering modules 102, that may be used in connection with the present invention.

As indicated above, the device 100 records media 103 from its surroundings, such as audio, video, images, text, by way of the content gathering modules 102. As will be described more fully below, a matching algorithm(s) (not shown) is implemented in the mobile device 100 that identifies occurrences of recognizable company “events,” which include any form of company occurrence in the recorded media. This is accomplished, for example, by comparing these known recognizable company events with the information that has been recorded via the content gathering modules 102. It should also be noted that at least some of the information recorded at the mobile device 100 may be received from a source other than the content gathering modules 102, such as via a network(s) from another device, or via a device otherwise connectable to the mobile device 100 (e.g., a digital camera connectable via wired or wireless means to the device 100). This recorded or received information is compared with the known recognizable company events to determine if there is a match. These known company events are illustrated in FIG. 1 as the company-provided input 120, which may be directly provided by company information via a network 122, via another network entity(s) serving as a proxy for the company, or via other company sponsored mechanisms. Thus, in one embodiment, the inputs for the matching algorithm includes the media gathered within the surroundings or neighborhood of the mobile device and the patterns or other data provided by entities (e.g., companies).

These occurrences of company events, i.e., matches of the known information and the recorded information, may be recorded in the respective company's database 124A or other designated storage location. More particularly, one embodiment involves recognizing the occurrence of a company event (e.g., company name or brand in graphic, text, audio or other media form) at the mobile device 100 by comparing the known company information 120 with the device-recorded information obtained via one or more of the modules 102. Upon recognition of a match, a corresponding entry is created in a database 124A and/or associated server 126 of the company corresponding to the matching company event. One server 126 may serve as a common target for multiple companies, from where it is then directed to an appropriate company server, or alternatively one or more companies may provide their own server 126 and/or database 124A.

In another embodiment, the company database is located at the device 100, as depicted by company database 124B. The operation of the company database 124B corresponds to that of an external company database 124A, and in one embodiment only the location of the database is different. By having the database 124B stored locally to the device 100, the corresponding data stays with the device 100. As will be described more fully below, a company(s) can subscribe to or otherwise obtain user permission to obtain data from the device's 100 associated database 124B. Otherwise, the data in a local database 124B is accessible to the device 100, such as for use by local applications.

In one embodiment, the information from one or more of the content gathering modules 102 is continuously gathered. In another embodiment, some information may be gathered at a given frequency, such as once every day, on the hour, etc. In another embodiment, a ranking algorithm(s) is implemented to rank matching results as a function of their frequency of occurrence. This ranking information may be provided to the server 126. In the illustrated embodiment, the server 126 stores data for multiple companies, such as companies A, B and C. As the example shows, the device 100 and/or other similar devices recorded 3 company “events” or “occurrences” (e.g., text, audio, graphic, video, or other media/multimedia) in a 1 hour time period. Two occurrences for company-B were recorded in a five hour period, and four occurrences were recorded for company-C during a two day period. In alternative embodiments, the recordings for each company may represent collective data from numerous devices 100, or from a single device 100.

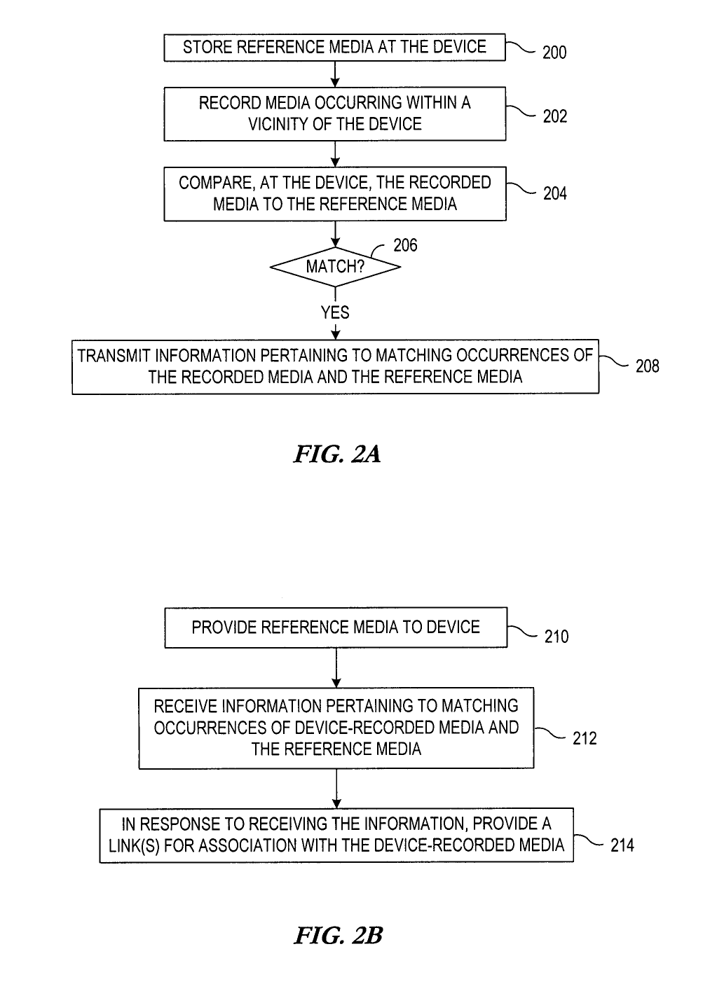

FIG. 2A is a flow diagram illustrating a representative manner in which a device, such as a mobile phone, identifies matching recorded and reference data. In the illustrated embodiment, reference media is stored 200 at the device. For example, company events or patterns may be stored at the device. The device records 202 media occurring within a vicinity of the device. For example, the device may record any one or more of images, audio, audiovisual, text, and/or other media occurring within a perceivable range of the device. A comparison 204 of the recorded media and the reference media is made, and if a match 206 exists, information pertaining to the matching occurrence(s) of the recorded media and the reference media is transmitted. For example, this may be transmitted via a network, for ultimate receipt by an external company database/server, a local company database, etc.

FIG. 2B is a flow diagram illustrating a representative manner in which a network element, such as a company server/database, provides links in response to receiving information identifying an occurrence(s) of a company “event.” In the illustrated embodiment, reference media is provided 210 to a device such as a mobile phone. The reference media may include company patterns (e.g., visual, audio, etc.). The company server may provide this information, or another entity can provide the information. The information pertaining to matching occurrences of device-recorded media and the reference media is received 212. In response, one or more links are provided 214 for association with the device-recorded media.

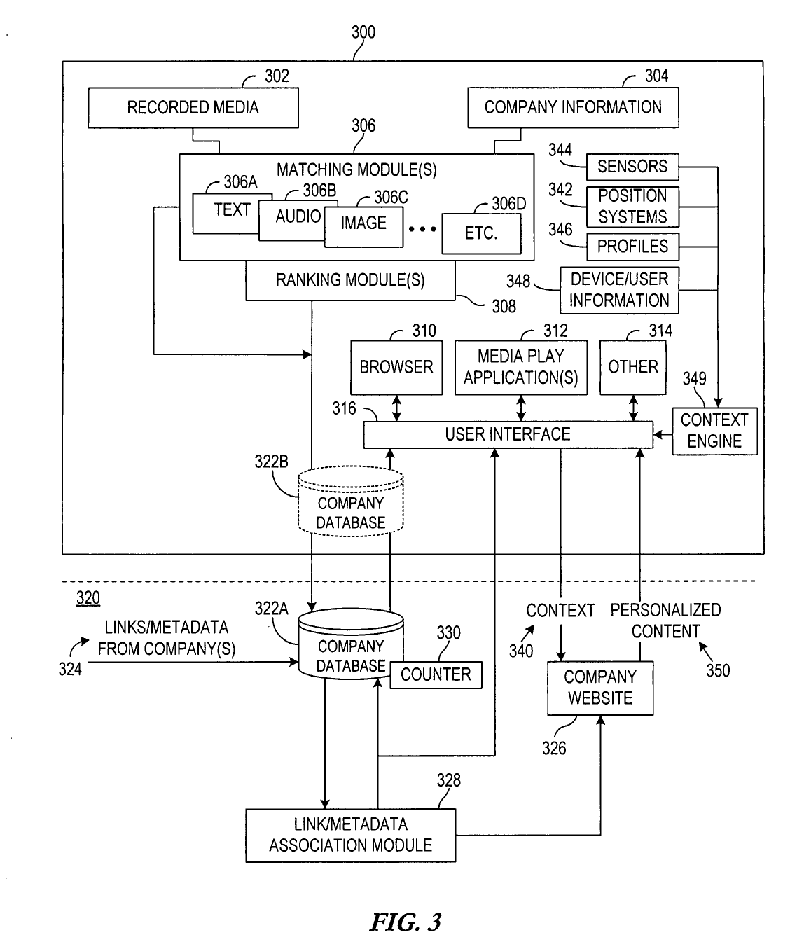

Various alternative and additional embodiments are now described. FIG. 3 is a diagram illustrating a representative embodiment of system for providing personalized advertisements to mobile users and generating feedback to advertising sources. The device 300 represents a communication device, such as a computer, mobile phone, PDA, etc. In addition to mobile devices, the device 300 may be a “wired” device such as a desktop computer. For example, a desktop computer or other workstation may be placed in a strategic location to monitor for audio or other media as described above. In other embodiments, the device 300 is a mobile device where the user is mobile and the device 300 moves to different locations.

The device 300 includes storage to store at least the recorded media 302. Company events 304 may be provided to, and optionally stored at, the device 300. As described above, these company events include “patterns” of data such as an image of a brand, audio pattern (e.g., company-specific sound associated with the company), and/or other particular media. For example, pattern data may be provided that identifies COMPANY-A. When this data is compared to the recorded media 302 via a pattern matching module, it can be determined whether the recorded media 302 includes an image, text, or other media that presents the visible “COMPANY-A.” The matching module(s) 306 represent the one or more modules, such as pattern matching modules, that can determine whether any of the recorded (i.e., gathered) media matches any of the company-provided information 304. The matching modules 306 of the illustrated embodiment include a text matching module 306A, audio matching module 306B, image (including video and/or other graphical data) matching module 306C, and other relevant matching modules 306D.

It should be recognized that the company information does not necessarily imply that the data has to be associated with a “company” or is provided directly by a “company.” Rather, “company” in this regard refers to any person(s) or entity that provides information for comparison. In the case where the invention is used for advertising purposes, the entity may be a “company,” and therefore this term is used for purposes of convenience. Further, the information may be provided by other entities at the direction of a company (e.g., person, entity, etc.), and does not have to be directly provided by this person(s) or entity. It should also be noted that the company/entity does not need to be involved at all—i.e., independent entities (e.g., advertising agencies, statistics and polling entities, etc.) as well as individuals can provide the information 304. Thus, the company information 304 represents any information provided as “reference” information to which the recorded media 302 is to be compared.

In one embodiment of the invention, a ranking module(s) 308 is provided. The ranking module 308 ranks the recognized company events (i.e., recorded media 302 that matches reference company information 304) as a function of their frequency of occurrence. For example, if a company name such as COMPANY-A is identified more often than other company/entity information, the ranking module 308 may rank COMPANY-A first in the ranking, until such ranking changes. The determined occurrences from the matching module 306 and/or the ranked occurrences from the ranking module 308 can be provided to a company database 322A available on a network 320, and/or a company database 322B provided locally within the device 300, or a company database otherwise accessible to the device 300. The information may be provided to an external company database 322A via non-networked means, such as being provided directly by the device 300 to the external company database 322A, downloaded from the device 300 to another computing and/or communication device which can then be provided to the database 322A, etc.

Examples of computing/communication devices which can obtain the information from the device 300 include, but are not limited to, handheld data collectors that receive the data from the device 300 via wired (e.g., USB, firewire, etc.) or wireless (e.g., Bluetooth, infrared, wireless local area networks, etc.) means, kiosks capable of directly or wirelessly receiving the information from the device 300, or the like. However, in one embodiment presented in FIG. 3, the information is provided from the device 300 to an external company database 322A via a network, such as a wireless/cellular network that can also access networks such as local area networks, the Internet, etc. Thus, the network 320 represents any one or more wired and/or wireless networks capable of communicating the information between the device 300 and the external company database 322A.

In another embodiment shown in FIG. 3, the company database is located at the device 300 itself, such as is depicted by the company database 322B. Where the company database 322B is local, an encountered event causes a record(s) to be written to the local company database 322B, whereby none of the information leaves the device 300. In such an embodiment the company(s) can subscribe to data extracted from the company database 322B, but unless subscribed, the company database 322B stays in the device 300 and no others have access to the company database 322B except for the local applications (e.g., image presentation application, video player, etc.) on the device 300 itself.

According to one embodiment of the invention, links are associated with at least some of the content associated with the company database 322A/B. These links generally represent references to another resource(s), and may be in the form of an HTTP link, text, images, etc. The links may be associated with the database 322A/B content in a variety of manners, including but not limited to inserting links in the primary content itself (e.g., any recorded or otherwise viewed content on the device), or under the form of metadata. As is known in the art, metadata generally refers to data about data. Companies, advertisers, or other person/entity can provide such links, metadata or other relevant information as shown by input 324 to the company database 322A/B. For example, companies can submit one or more links to their websites 326 or other sites, documents, files, coupons, etc. These links may be attached to the detected company events in user's devices (e.g., device 300). Thus, links/metadata may be associated with the media 302 that has been found to match company information 304. These links may be submitted a single time, multiple times, periodically, whenever changed, or at any other time or event desired.

The links are inserted in the primary content or as metadata such that when the user comes across the content in which a company event occurs, the device 300 offers links towards company products, discounts, coupons, directions, contact information, and/or other company-related information. The link/metadata association module 328 associates the company-related information with the data. For example, the link/metadata association module 328 may be implemented in software operable via a processing device(s), whereby the instructions associate one or more particular links with certain company data. Upon or after receipt of the detected company event(s) from the device 300, the relevant link(s) can then be provided to the device 300 to be associated with recorded media 302 that has been stored.

As an example, an image capturing module (e.g., camera) in a mobile device 300 may capture an image of COMPANY-A or of a product/brand associated with this company, which is compared to company information 304 using at least the image matching module 306C. A match is found, which is recorded in the company database 322A/B. Links/metadata 324 is provided by COMPANY-A, and associated with the company's data via the link/metadata association module 328. One or more of the links of COMPANY-A are then provided to the mobile device 300 to be associated with the content of the recorded media 302. The user can then use a user interface (UI) 316, which may include a browser 310, a media play application 312, and/or other 314 UI to use the link or metadata. For example, the user may click on a link, which brings the user to the company website 326 or other site.

In one embodiment, the phone/user's context 340 can be included with the request, so that the company can provide personalized content 350 for that user. Information directed to/from the UI 316 may be accomplished via a transmitter and a receiver, or a transceiver, or other transmitting and receiving modules (not shown). The context may include, for example, location information, the model or other relevant information of the device 300, user's biometrics and motion, preferences, etc. In this manner, personalized content may be provided. For example, assume that the “context” 340 includes the user's location. The user's location may be determined in any known manner, using positioning systems 342 such as the use of global positioning systems (GPS), a mobile device's location/cell identifier, or the like. A link to the company website 326 may then provide a discount and/or coupon to a company store that is in the user's vicinity. As another example, user biometrics may provide context information. In such a case, sensors 344 may be employed. For example, sensors 344 may sense a user's heart rate, temperature, blood pressure, fat content, etc. Sensors 344 may also be used for other context 340 information other than biometrics, such as user motion, ambient temperature and other environmental conditions, etc. User profile information 346 may also represent all or a portion of the user's context 340, such as whether the user is in a meeting (e.g., do not disturb), a theatre (e.g., silent notification) or the like. Other context 340 information may include device or user information 348, such as information stored in a SIM card, International Mobile Subscriber Identity (IMSI), International Mobile Equipment Identity (IMEI), Mobile Station ISDN/PSTN Number (MSISDN), or any other identification associated with the terminal. For example, the IMEI is a parameter that uniquely identifies an individual wireless phone or communicator. Generally, the IMEI is automatically transmitted by the phone when the network asks for it. The IMSI generally refers to the primary number used to identify a user on a GSM network, and is typically used in conjunction with the mobile telephone network for call routing. The MSISDN is a mobile number used by GSM/DCS networks that contains information such as the country code, national destination code, HLR identifier and a subscriber number.

Any of these and/or other types of information from the context-related modules 342, 344, 346, 348 may be included as context 340 information, and the aforementioned information types are merely representative and clearly do not represent an exhaustive list. In any event, the device 300 can send one or more parameters to establish a context 340 of the user/device. In one particular embodiment, when opening a link in a browser 310, the device 300 sends a set of parameters including the device's 300 context 340 in, for example, an HTTP request. Any one or more of the context-related modules (e.g., modules 342, 344, 346, 348) may include the processing ability to formulate its request to be provided via the UI 316. In another embodiment, a context engine 349 or other processing unit can gather the data from any one, more or all of the modules 342, 344, 346, 348 (and/or others), and introduce this data into requests provided by UI 316. For example, in one embodiment, an HTTP request may be issued through the UI 316, and the context engine 349 widens the set of parameters with sensory data, position data, etc. In any event, the company website 326 can take the phone/user's context 340 into account and offer the personalized content 350.

When the user comes across or otherwise “consumes” recorded content with inserted links, the device 300 will display or otherwise present these links, and may offer the user choices, such as whether to open a browser 310 window to these links or alternatively to download and play the advertisement via a media play application(s) 312 or other application 314. This presentation of the link(s) to the user may be visual, audible, tactile, and/or any other perceptible presentation.

In one embodiment, a counter function is provided to count the occurrence frequency of detected company events. In one embodiment, this may be provided using a counter 330 associated with the company database 322A/B. In such an embodiment, if the same company name is encountered several times, the counter field of the entry is automatically incremented in order to reflect the occurrence frequency in the company database 322A/B. In this embodiment, the counter may count the frequency of occurrence the detected company events gathered by multiple devices 300, to thereby provide a collective count value. In another embodiment, a counter field may be provided with the information provided by a particular device 300 to the company database 322A/B, whereby the device 300 includes the counter function and provides this information to the database 322A/B.

The company database 322A/B may include information for multiple companies. A third party may therefore provide a server and database 322A/B to collect the data for various companies. Alternatively, a company (including person, entity, etc.) can provide its own database 322A/B. In an embodiment where the database 322A/B stores information for one or more companies, a service can be offered to the companies, where the service provides statistics or individual occurrences of company events in the surrounding of the specific user(s).

In one embodiment of the invention, companies can subscribe to the data obtained by devices such as device 300. Such a subscription may be a one-time subscription, a perpetual subscription, or something in between. For example, a company can subscribe to periodically receive the data obtained by such devices, or could subscribe to once receive all of the information the device has accumulated over a period of time. The data may include, but is not limited to, information indicating matches of recorded data and the reference company information. This data may also include statistics, such as the number and/or frequency of occurrence of particular occurrences, companies, etc. This data may be referred to herein as a user's “life data.” Companies can subscribe to individuals' life data, or alternatively individuals can offer their life data as input for companies, who may pay for this opportunity. In such an embodiment, a client in the user's device 300 provides to the subscriber company data regarding the frequency of occurrence of the company's (or competitor's) advertisements or events (e.g., ring tone) in the users' everyday life/surroundings. This information can provide insight for the company regarding the penetration rate of its own, and/or its competitors', advertisements in various population segments.

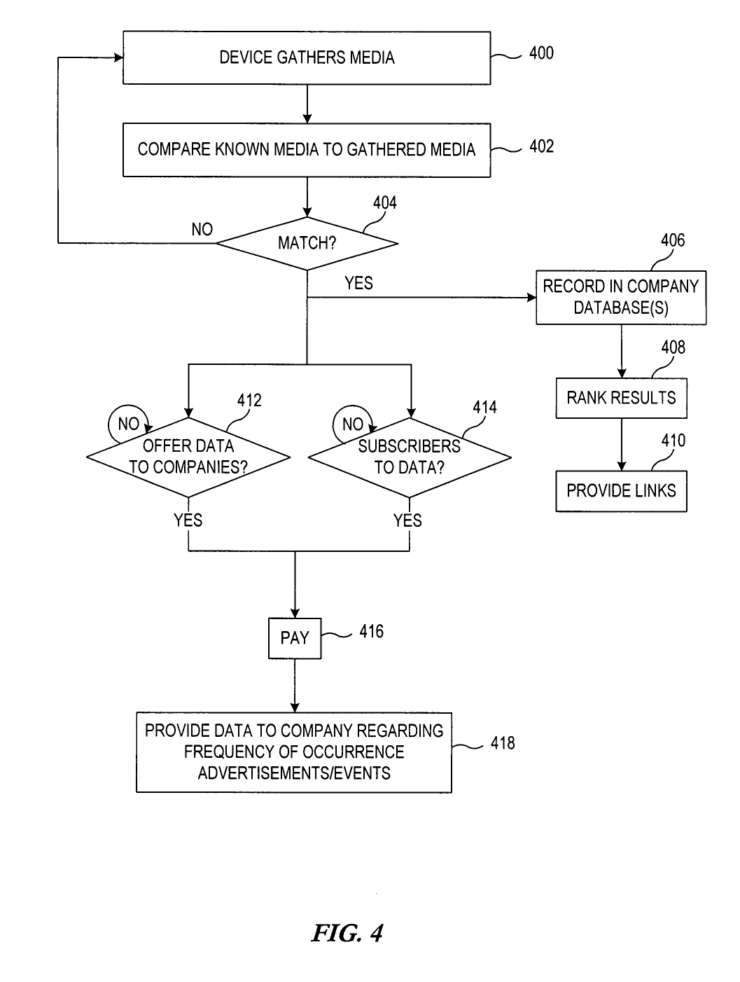

FIG. 4 is a flow diagram illustrating an exemplary method in accordance with one embodiment of the present invention, where such life data is provided to the company(s). As previously described, the device (e.g., mobile phone, PDA, etc.) gathers media as shown at block 400. The gathered information is compared 402 to known media, such as company patterns (company “events”) which serve as the reference information to which the comparison is made. If there is a match as determined at decision block 404, the gathered content may be recorded 406 in the company database(s). The results may optionally be ranked 408, and links may be provided 410. For example, the company may provide 410 links to those users who subscribed to a company advertisement feedback service. Such links may be inserted in the primary content. For example, something that was recorded in the past may get updated each time with the newly provided links, such as when a company updates its website(s). The device can check the occurrences of this company's events recorded in the past in its company database, and update them with the new links. In this manner, the updated links will be provided to the user when he/she consumes content from the past.

At any point after the device has obtained some information, the user may offer 412 the data to the companies, and/or the companies may become subscribers 414 to the data. In one embodiment, the recipient company pays 416 for this service, and data is provided 418 to the company. This data may include, for example, data regarding the frequency of occurrence of advertisements or events. Other data may include the types of advertisements/events (e.g., audio, images, etc.). Other informational and/or statistical data may also be provided.

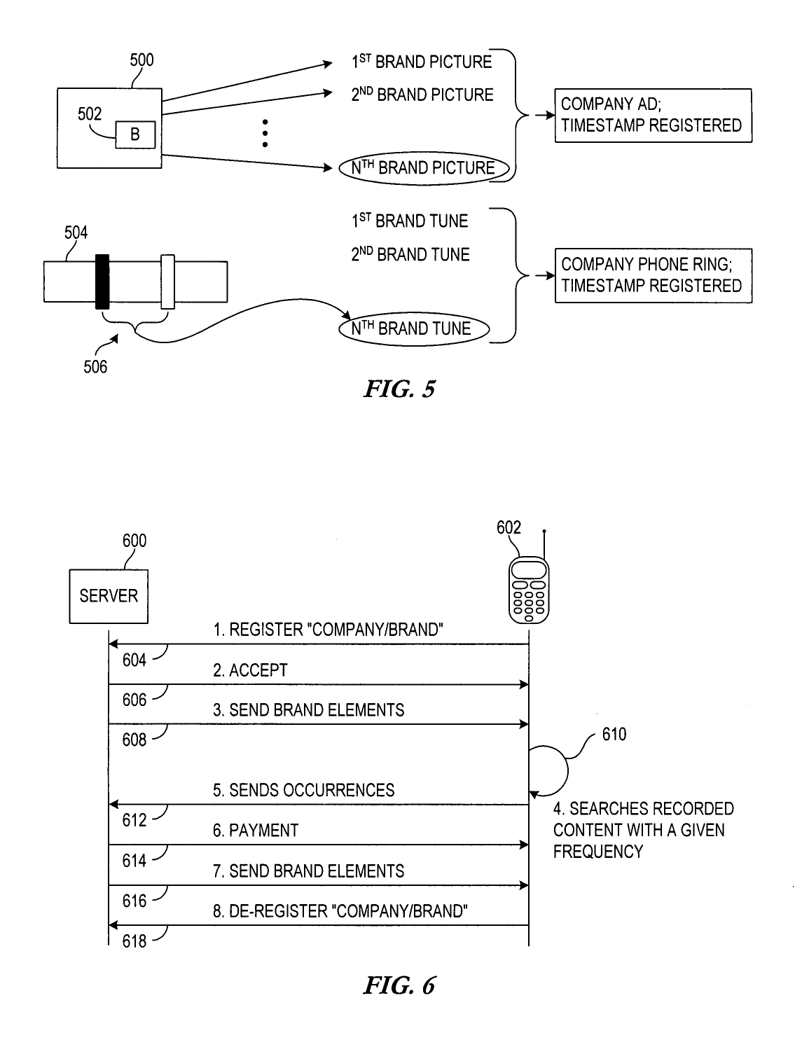

FIG. 5-8 illustrate representative examples of different aspects of the invention. FIG. 5 is a block diagram illustrating a process of matching content with company brand information, where companies provide updated brand elements to which the match can be performed. In one embodiment, an engine is implemented in the mobile phone or other device that searches for content, such as company content in terms of encountered words (e.g., name of the company heard in audio content, seen in text, seen in a picture, etc.). The engine may search for such content continuously, at a given frequency (e.g., once per day), based on an event (e.g., when manually instructed to record content), etc.

The block 500 represents any sample occurrence, whereby a camera or other image gathering device takes a picture of the surroundings. Some portion of that picture may include a brand name, company name, or the like which is shown as the brand “B” 502. Block 504 represents an audio sample, where the portion 506 is a recognized “occurrence” of a company event (e.g., a company-related ringtone, advertising jingle, etc.). These represent examples of visual/graphic and audio recognition of company events, but as described throughout, the invention is clearly not limited to the exemplary content types of FIG. 5.

Comparisons are made between the gathered data 500, 504 and reference data such as image and audio patterns provided by the company associated with the particular brand. This matching function may be executed on the device as a background process, whereby the captured surrounding content is compared with reference data provided by, for example, the company. Each of the pictures 500 resulting in a match of the brand B 502 to the reference data are shown as the 1^{st} brand picture, 2^{nd} brand picture, through the n^{th} brand picture. Similarly, each of the audio segments 506 resulting in a match to the reference data are shown as the 1^{st} brand tune, 2^{nd} brand tune, through the n^{th} brand tune.

In this manner, the engine in the device recognizes if an occurrence(s) of a company name (or other particular data being monitored) has been recorded, and in response creates an entry in a company database. The recognition part of the engine may include various kinds of matching algorithms to match text, images, audio, etc. A timestamp may be registered upon recognition of each match of the recorded content and the reference content. In the example of FIG. 2, a timestamp may be registered upon recognition of a match that has occurred a certain number of times, such as upon the occurrence of the n^{th} brand picture or n^{th} brand tune.

In some embodiments of the invention, the engine can offer a service to companies (including individuals or other entities). This service may include, for example, providing statistics and/or notifications of individual occurrences of company events in the surroundings or vicinity of the specific user. FIG. 6 illustrates a signal flow diagram of a representative embodiment of an advertisement feedback service. The example illustrates an exemplary process for facilitating user registration to brand elements of a certain company, and the providing of brand elements by the company to which the matching can be performed.

In the illustrated embodiment, the server 600 represents the company or other entity. For example, the server 600 may represent a company database as previously described. A device user, such as a user of the mobile phone 602, registers 604 the particular company, brand, or other specific item(s) to be monitored. For example, the mobile device 602 may register the company name/brand “NOKIA” with the company server 600. The server 600 may provide an accept 606 or other acknowledgement notification, and further send 608 the particular brand elements of interest to the company. In other words, the brand elements sent 608 from the server 600 to the client at the device 602 specifies or otherwise makes reference to the particular name, brand, or other items to be monitored by the client at the device 602. The device 602 includes a client, such as an advertising monitoring client, that may search 610 recorded content continuously or non-continuously. For example, the example of FIG. 6 shows that the device 602 searches 610 recorded content periodically, such as once every day. Any matching occurrences are sent 612 to the server 600. In one embodiment, the device 602 user is provided with some type of payment 614. This payment may be in any form, and may include money, credit, coupons, discounts, etc. Or, the “payment” may simply be information that may be of interest to the user. In one embodiment, the server sends 616 the brand elements, which may include links. The links may be, for example, inserted into the primary content or in the form of metadata. The device 602 user may, if desired, de-register 618 the company name, brand or other item to discontinue the particular service between the parties 600, 602.

It should be noted that the database/server 600 of company links can be hosted by a service provider on a website, and users can register from the website. In another embodiment, a distributed approach may be followed, such as where companies provide links from their homepages. Further, users may exchange company links in the proximity.

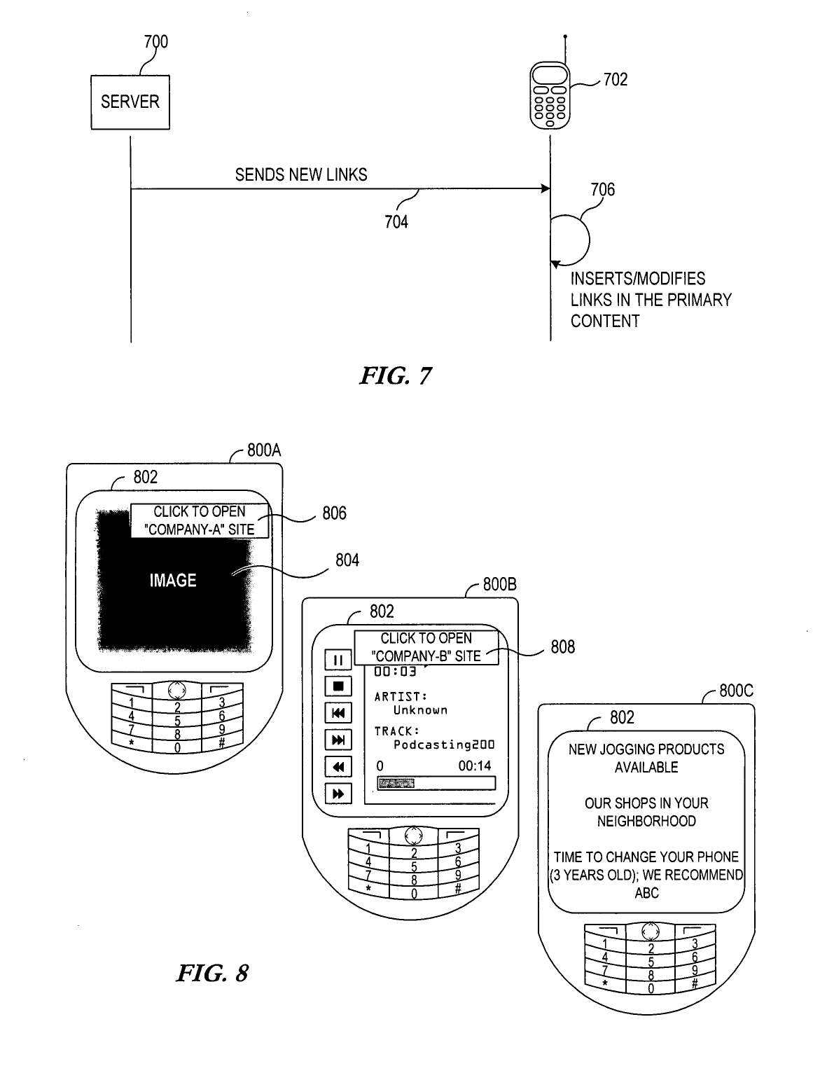

As previously indicated, links can be updated in the primary content or in the metadata whenever the company provides a new, updated set of links. FIG. 7 illustrates one representative process for updating links, which may be in the company's interest. The server 700 associated with the links database can send 704 the new links to the device 702. The device 702 may then insert and/or modify 706 the links in the primary content.

When the user clicks on (or otherwise activates) the links provided by the company, the device's 702 context can be inserted or otherwise included such that the company can provide personalized content for the user. Thus, it may be in the company's interest to update the links in a personalized and/or context-aware fashion. As previously described, this “context” may include, for example, location information, information associated with the device 702 such as a device identifier or model, user's biometrics, whether the device is in motion, etc. When the user comes across recorded content to which links are inserted, the device engine (e.g., client) may display these links and offer the user the choice as to the manner of accessing the links. In one embodiment, when the user opens a link (e.g., via a browser), the device sends a set of parameters including the device's context such that the company website/server can take these parameters into account and offer personalized content. In one particular embodiment, these parameters may be sent with the link request message (e.g., HTTP request message) generated when the user clicks on or otherwise activates the link. One such example is shown in Example 1 below:

http request<cellID=0×111; netID=0×112; phone=6630 since 2 years 1 months 2 days; user motion=still; heartrate=90>

### EXAMPLE 1

This example indicates that the HTTP request includes information such as a cell identifier (e.g., cellID=0×111), a network identifier (e.g., netID=0×112), a phone model (e.g., 6630) and length of use by the user (e.g., 2 years, 1 month and 2 days), the user's motion (e.g., still), the user's heart rate (e.g., pulse is 90), etc.

FIG. 8 illustrates a few representative examples of the presentation of links and the personalization of content. The device 800A includes a display 802 where the user-recorded content, i.e., image 804, is displayed. As previously described, the user may provide the content to the company database, which in turn provides a link(s) 806 that is inserted into the primary content or in the form of metadata. In one embodiment, when the user opens the link(s) the device 800A sends a set of parameters including the device's context, such as described above and in connection with Example 1. The device 800B illustrates another example, where an audio recording matches a company event and a link 808 is similarly provided.

It should be noted that the actual “link” need not be limited to the boundary shown by links 806 and 808. Rather, the link may be associated with the entire screen image or any subset thereof. For example, where the link 806 is associated with the entire image 804, the user can click at any portion of the image to activate the link. In other words, the illustrated “boundary” of links 806 and 808 does not suggest that the link is limited to the text boundary. Also, the illustrated links 806, 808 need not be text, and can be more dynamic user interface components with any one or more of text, images, audio, animations and/or other presentations related to the company. One example is a pop-up image/animation. In one embodiment, such a pop-up item may be indiscrete, so as not to dominate the user interface (UI) focus and occupy only a limited UI space.

Further, the “links” may be HTTP links, but can also be any kind of document such as text, picture, etc. As an example use case, a user can click on a text link which can open a web page associated with that link. Or activating a link can open a text box with the address(es) of a company shop in the vicinity, provide a picture of a company shop in the vicinity, open map software and show the map(s) and/or directions to the company shops in the vicinity, open a document (e.g., PDF) regarding current company offerings, open a shopping site offering the product associated with the link, add the product associated with the link to an online shopping cart, and/or other examples. Such links can be differentiated by types, such as an icon(s) close to the link can show that the link is related to position, HTTP link, document, shopping, etc.

Device 800C illustrates personalized and/or context-aware content that may be provided to a user. For example, if the context information establishes that the user is in motion (e.g., jogging) or is otherwise interested in exercise, information and/or links may be provided to allow the user to locate new jogging products. As another example, the context information may include the user's location, in which the local store locations, maps, or other information regarding company stores in the user's vicinity may be provided.

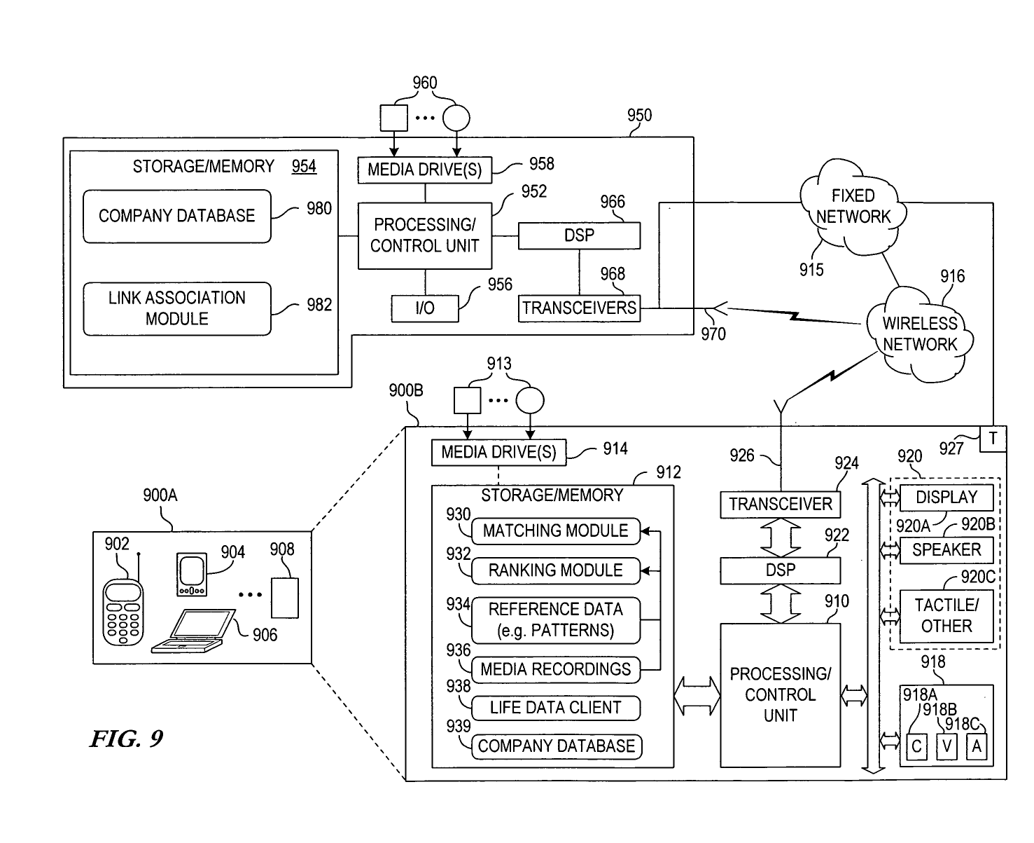

A representative system in which the present invention may be implemented or otherwise utilized is illustrated in FIG. 9. The communication device(s) 900A represents any communication device capable of gathering content and communicating with a server/database as previously described. In the illustrated embodiment, the communication device 900A represents a mobile device capable of communicating over-the-air (OTA) with wireless networks and/or capable of communicating via wired networks. By way of example and not of limitation, the device 900A includes mobile phones (including smart phones) 902, personal digital assistants 904, computing devices 906, and other networked terminals 908.

The representative terminal 900A utilizes computing systems to control and manage the conventional device activity as well as the device functionality provided by the present invention. For example, the representative wireless terminal 900B includes a processing/control unit 910, such as a microprocessor, controller, reduced instruction set computer (RISC), or other central processing module. The processing unit 910 need not be a single device, and may include one or more processors. For example, the processing unit may include a master processor and one or more associated slave processors coupled to communicate with the master processor.

The processing unit 610 controls the basic functions of the terminal 900B as dictated by programs available in the program storage/memory 912. The storage/memory 912 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the terminal. The storage 912 may also include one or more of other types of read-only memory (ROM) and programmable and/or erasable ROM, random access memory (RAM), subscriber interface module (SIM), wireless interface module (WIM), smart card, or other fixed or removable memory device/media. The programs may also be provided via other media 913, such as disks, CD-ROM, DVD, or the like, which are read by the appropriate interfaces and/or media drive(s) 914. The relevant software for carrying out terminal operations in accordance with the present invention may also be transmitted to the terminal 900B via data signals, such as being downloaded electronically via one or more networks, such as the data network 915 or other data networks, and an intermediate wireless network(s) 916 in the case where the terminal 900A/900B is a wireless device such as a mobile phone.

For performing other standard terminal functions, the processor 910 is also coupled to user input interface 918 associated with the terminal 900B. The user input interface 918 may include, for example, a keypad, function buttons, joystick, scrolling mechanism (e.g., mouse, trackball), touch pad/screen, or other user entry mechanisms (not shown). The user input interface 918 also includes any one or more of the media capturing devices that may be used in connection with the invention. For example, the user input interface 918 may include a camera (C) 918A, video camera (V) 918B, audio recorder (A) 918C, and/or any other such media gathering modules. These and other user input components are coupled to the processor 910 and/or other computing elements as is known in the art.

A user interface (UI) 920 may be provided, which allows the user of the terminal 900A/B to perceive information visually, audibly, through touch, etc. For example, one or more display devices 920A may be associated with the terminal 900B. The display 920A can display captured images and video, as well as present links and other information provided by the company or other entity. A speaker(s) 920B may be provided to audibly present captured audio, ringtones, voice, audio information from the company, etc. Other user interface (UI) mechanisms can also be provided, such as tactile 920C or other feedback. The gathered information, reference information (e.g., company events), links and other information from the company server/database, and other information may be provided by any type of presentation perceivable by the user.

The exemplary mobile device 900B of FIG. 9 also includes conventional circuitry for performing wireless transmissions over the wireless network(s) 916. The DSP 922 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 924 includes at least a transmitter and receiver, thereby transmitting outgoing radio signals and receiving incoming radio signals, generally by way of an antenna 926. Where the device 900B is a non-mobile or mobile device, it may include a transceiver (T) 927 to allow other types of wireless, or wired, communication with networks such as the Internet. For example, the device 900B may communicate via a proximity network (e.g., IEEE 802.11 or other wireless local area network), which is then coupled to a fixed network 915 such as the Internet. Peer-to-peer networking may also be employed. Further, a wired connection may include, for example, an Ethernet connection to a network such as the Internet. These and other manners of ultimately communicating between the device 900A/B and the server 950 may be implemented.

In one embodiment, the storage/memory 912 stores the various client programs and data used in connection with the present invention. For example, the storage/memory 912 includes storage to store clients/applications such as the matching module 930 and ranking module 932. The storage 912 may store the reference data 934, such as patterns or other information provided by a company, as well as the media recordings 936 that represent the media gathered by the camera, video camera, audio recorder, and/or other content gathering modules. For example, the client 930 may include instructions to perform operations including comparing the media recordings 936 to the reference data 934.

As previously indicated, companies (including any entity) can subscribe to individuals' “life data,” or alternatively individuals can offer their “life data” as input for companies who will pay for this opportunity. A client, shown as the life data client 938, provides to the subscriber company/entity particular data about the frequency of occurrence of the company's (perhaps also or alternatively the competitor's) advertisements or events in the users' surroundings, which provides insight for the company regarding the penetration rate of its own advertisements in various population segments.

It should be recognized that the modules 930, 932, 938 may be separate modules operable in connection with the processor 910, may be single module performing each of these functions, or may include a plurality of such modules performing the various functions. In other words, while the modules are shown as multiple software/firmware modules, these modules may or may not reside in the same software/firmware program. It should also be recognized that one or more of these functions may be performed using hardware. For example, a compare function may be performed by comparing the contents of hardware registers or other memory locations using hardware compare functions. These client and data modules are representative of the types of functional and data modules that may be associated with a terminal in accordance with the invention, and are not intended to represent an exhaustive list.

FIG. 9 also depicts a representative computing system 950 operable on the network. One or more of such systems 950 may be available via a network(s) such as the wireless 916 and/or fixed network 915. For example, certain companies may have their own server and company database (e.g., their own server 950). In other embodiments, one, more or all entities utilize a common server and associated database (e.g., server 950) on behalf of these entities. For example, a common server 950 may be a third party server that hosts the company event information, links, etc., thereby allowing interested companies to utilize the invention without having to themselves host the information.

In one embodiment, the computing system 950 represents the server and associated company database as previously described. The server system 950 may be a single system or a distributed system. The illustrated computing system/server 950 includes a processing arrangement 952, which may be coupled to the storage/memory 954. The processor 952 carries out a variety of standard computing functions as is known in the art, as dictated by software and/or firmware instructions. The storage/memory 954 may represent firmware, media storage, and/or memory. The processor 952 may communicate with other internal and external components through input/output (I/O) circuitry 956. The computing system 950 may also include media drives 958, such as hard and floppy disk drives, CD-ROM drives, DVD drives, and other media 960 capable of reading and/or storing information. In one embodiment, software for carrying out the operations at the computing system 950 in accordance with the present invention may be stored and distributed on CD-ROM, diskette, magnetic media, removable memory, or other form of media capable of portably storing information, as represented by media devices 960. Such software may also be transmitted to the system 950 via data signals, such as being downloaded electronically via a network such as the data network 915, Local Area Network (LAN) (not shown), wireless network 916, and/or any combination thereof.

In accordance with one embodiment of the invention, the storage/memory 954 and/or media devices 960 store the various programs and data used in connection with the present invention. For example, the single or distributed server 950 includes the company database 980, which can store, among other things, matching occurrences of recorded media and company provided reference data. An application or client shown as the link association module 982 can be implemented to insert links into the content or in the form of metadata, as previously described. In one embodiment, the module 982 includes instructions operable in connection with the processing system 952 to associate links, such as HTTP hyperlinks, with the content or as metadata as is known in the art. As previously indicated, a company database 980 may alternatively, or additionally, be provided within the device 900B as depicted by the company database 939.

The illustrated computing system 950 also includes DSP circuitry 966, and at least one transceiver 968 (which is intended to also refer to discrete transmitter/receiver components). While the server 950 may communicate with the data network 915 via wired connections, the server may also/instead be equipped with transceivers 968 to communicate with wireless networks 916 whereby an antenna 970 may be used.

Hardware, firmware, software or a combination thereof may be used to perform the functions and operations in accordance with the invention. Using the foregoing specification, some embodiments of the invention may be implemented as a machine, process, or article of manufacture by using standard programming and/or engineering techniques to produce programming software, firmware, hardware or any combination thereof. Any resulting program(s), having computer-readable program code, may be embodied within one or more computer-usable media such as memory devices or transmitting devices, thereby making a computer program product, computer-readable medium, or other article of manufacture according to the invention. As such, the terms “computer-readable medium,” “computer program product,” or other analogous language are intended to encompass a computer program existing permanently, temporarily, or transitorily on any computer-usable medium such as on any memory device or in any transmitting device.

As described above, the present invention includes numerous embodiments. A number of representative embodiments are set forth below. It should be recognized that the following embodiments are, as indicated, representative, and the invention includes further embodiments as set forth in the Specification and drawings.

One embodiment involves a method comprising storing reference media at a device; recording media occurring within a vicinity of the device; comparing the recorded media to the reference media at the device; and transmitting from the device information pertaining to matching occurrences of the recorded media and the reference media.

Various alternative embodiments of such a method are set forth below.

An embodiment of the method further comprises ranking results of the matching occurrences of the recorded media and the reference media as a function of their frequency of occurrence. A further embodiment of the method comprises transmitting the results from the device to one or more entities associated with the results.

An embodiment of the method further comprises receiving one or more links associated with the matching occurrences of the recorded media and the reference media.

An embodiment of the method further comprises the device providing context information of the device, and receiving context-specific information in response to transmitting the information pertaining to matching occurrences of the recorded media and the reference media.

An embodiment of the method further comprises receiving, at a network element, the information pertaining to matching occurrences of the recorded media and the reference media, and recording the information in a database. A further embodiment of the method comprises associating one or more links with the recorded content that matched the reference media.

An embodiment of the method further comprises transmitting from the device a set of the information pertaining to matching occurrences of the recorded media and the reference media occurring over a period of time. A further embodiment of the method comprises receiving payment for providing the set of the information.

In one embodiment of the method, the information pertaining to matching occurrences comprises the matching media itself.

In one embodiment of the method, the information pertaining to matching occurrences comprises a count of a number of the matches that occurs.

In one embodiment of the method, recording media comprises continuously recording at least some of the media.

In one embodiment of the method, recording media comprises recording the media at one or more of particular times and in response to particular events.

An embodiment of the method further comprises receiving the reference media from one or more different entities.

One embodiment involves a method comprising providing reference media to a device; receiving information pertaining to matching occurrences of device-recorded media and the reference media; and in response to receiving the information, providing one or more links for association with the device-recorded media.

Various alternative embodiments of such a method are set forth below.

An embodiment of the method further comprises creating an entry in a database corresponding to the received information.

An embodiment of the method further comprises receiving context information associated with the device, and wherein providing one or more links comprises providing context-specific links based on the context information associated with the device.

An embodiment of the method further comprises subscribing to receive a set of information corresponding to the matching occurrences of device-recorded media and the reference media occurring over a period of time.

An embodiment of the method further comprises recording a count of the information received that pertains to matching occurrences of device-recorded media and the reference media.

An embodiment of the method further comprises providing one or more replacement links to update the links associated with the device-recorded media.

One embodiment involves an apparatus comprising one or more media gathering devices to obtain external media at the apparatus; memory to store reference media and the external media; a compare module to compare the external media to the reference media, and to identify matching occurrences of the external media and the reference media; and a transmitting module configured to transmit information pertaining to the identified matching occurrences of the external media to the reference media.

Various alternative embodiments of such an apparatus are set forth below.

An embodiment of the apparatus comprises a ranking module coupled to the compare module and configured to rank a plurality of the identified matching occurrences as a function of their frequency of occurrence.

In one embodiment of the apparatus, the media gathering devices comprise one or more media capturing devices configured to capture media within a vicinity of the apparatus. In a further embodiment of the apparatus, the one or more media gathering devices comprise any one or more of a camera, video recorder, and audio recorder.

In one embodiment of the apparatus, the media gathering devices comprise one or more content receiving modules configured to receive media transmitted to the apparatus. In a further embodiment of the apparatus, the one or more content receiving modules comprise any one or more of a short message service module, a multimedia messaging service module, an e-mail module, an instant messaging module, a really simple syndication reader, a browser module, and a podcast module.

An embodiment of the apparatus comprises a user interface to present one or more links received in response to transmitting the information pertaining to the identified matching occurrences of the external media to the reference media.

In one embodiment of the apparatus, a user interface is configured to initiate a request for transmission to a destination corresponding to at least one of the received links, wherein the request includes context information. In another embodiment the apparatus comprises one or more sensors to ascertain information for use as at least part of the context information. In another embodiment of the apparatus comprises one or more position systems to identify an approximate location of the apparatus for use as at least part of the context information. In another embodiment of the apparatus, any one or more of profile information, user information and device information forms at least part of the context information.

An embodiment of the apparatus comprises a processing system and a life data module executable on the processing system, wherein the processing system is configured to execute the life data module to provide stored data regarding the frequency of occurrence of the identified matching occurrences in a vicinity of the apparatus.

One embodiment involves a server comprising a transmitting module configured to transmit reference media for use by at least one device; a receiving module configured to receive information pertaining to matching occurrences of the reference media and media obtained by the device; a database to store at least links; and a processing system configured to direct the transmitting module to send one or more of the links, identified by the matching occurrences received, for association with the media obtained by the device.

Various alternative embodiments of such a server are set forth below.

In one embodiment of the server, the database is configured to further store the media obtained by the device that and received via the receiving module.

In one embodiment of the server, the processing system is further configured to modify one or more of the links to be sent based on context information received from the device.

An embodiment of the server comprises a link association module executable by the processing system to associate the links to be sent with the media obtained by the device.

One embodiment involves a computer-readable medium having instructions stored thereon which are executable by a computing system for identifying occurrences of reference media by performing steps comprising storing reference media at a device; recording media occurring within a vicinity of the device; comparing the recorded media to the reference media at the device; and transmitting from the device information pertaining to matching occurrences of the recorded media and the reference media.

One embodiment involves a computer-readable medium having instructions stored thereon which are executable by a computing system for facilitating advertising by performing steps comprising providing reference media to a device; receiving information pertaining to matching occurrences of device-recorded media and the reference media; and in response to receiving the information, providing one or more links for association with the device-recorded media.

From the description provided herein, those skilled in the art are readily able to combine software created as described with appropriate general purpose or special purpose computer hardware to create a computing system and/or computing subcomponents embodying the invention, and to create a computing system and/or computing subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
storing reference media at a device;
recording media occurring within a vicinity of the device;
comparing the recorded media to the reference media at the device; and
providing information pertaining to matching occurrences of the recorded media and the reference media.

2. The method of claim 1, further comprising ranking results of the matching occurrences of the recorded media and the reference media as a function of their frequency of occurrence.

3. The method of claim 2, further comprising transmitting the results from the device to one or more entities associated with the results.

4. The method of claim 1, further comprising receiving one or more links associated with the matching occurrences of the recorded media and the reference media.

5. The method of claim 1, further comprising the device providing context information of the device, and receiving context-specific information in response to providing the information pertaining to matching occurrences of the recorded media and the reference media.

6. The method of claim 1, further comprising receiving, at a network element, the information pertaining to matching occurrences of the recorded media and the reference media, and recording the information in a database.

7. The method of claim 6, further comprising associating one or more links with the recorded content that matched the reference media.

8. The method of claim 1, further comprising locally receiving, at the device, the information pertaining to matching occurrences of the recorded media and the reference media, and recording the information in a local database.

9. The method of claim 1, further comprising transmitting from the device a set of the information pertaining to matching occurrences of the recorded media and the reference media occurring over a period of time.

10. The method of claim 9, further comprising receiving payment for providing the set of the information.

11. The method of claim 1, wherein the information pertaining to matching occurrences comprises the matching media itself.

12. The method of claim 1, wherein the information pertaining to matching occurrences comprises a count of a number of the matches that occurs.

13. The method of claim 1, wherein recording media comprises continuously recording at least some of the media.

14. The method of claim 1, wherein recording media comprises recording the media at one or more of particular times and in response to particular events.

15. The method of claim 1, further comprising receiving the reference media from one or more different entities.

16. A method comprising:
providing reference media to a device;
receiving information pertaining to matching occurrences of device-recorded media and the reference media; and
in response to receiving the information, providing one or more links for association with the device-recorded media.

17. The method of claim 16, further comprising creating an entry in a database corresponding to the received information.

18. The method of claim 16, further comprising receiving context information associated with the device, and wherein providing one or more links comprises providing context-specific links based on the context information associated with the device.

19. The method of claim 16, further comprising subscribing to receive a set of information corresponding to the matching occurrences of device-recorded media and the reference media occurring over a period of time.

20. The method of claim 16, further comprising recording a count of the information received that pertains to matching occurrences of device-recorded media and the reference media.

21. The method of claim 16, further comprising providing one or more replacement links to update the links associated with the device-recorded media.

22. An apparatus comprising:
one or more media gathering devices to obtain external media at the apparatus;
memory to store reference media and the external media;
a compare module to compare the external media to the reference media, and to identify matching occurrences of the external media and the reference media; and
a transmitting module configured to transmit information pertaining to the identified matching occurrences of the external media to the reference media.

23. The apparatus of claim 22, further comprising a ranking module coupled to the compare module and configured to rank a plurality of the identified matching occurrences as a function of their frequency of occurrence.

24. The apparatus of claim 22, wherein the media gathering devices comprise one or more media capturing devices configured to capture media within a vicinity of the apparatus.

25. The apparatus of claim 24, wherein the one or more media gathering devices comprise any one or more of a camera, video recorder, and audio recorder.

26. The apparatus of claim 22, wherein the media gathering devices comprise one or more content receiving modules configured to receive media transmitted to the apparatus.

27. The apparatus of claim 26, wherein the one or more content receiving modules comprise any one or more of a short message service module, a multimedia messaging service module, an e-mail module, an instant messaging module, a really simple syndication reader, a browser module, and a podcast module.

28. The apparatus of claim 22, further comprising a user interface to present one or more links received in response to transmitting the information pertaining to the identified matching occurrences of the external media to the reference media.

29. The apparatus of claim 22, wherein the user interface is configured to initiate a request for transmission to a destination corresponding to at least one of the received links, wherein the request includes context information.

30. The apparatus of claim 29, further comprising one or more sensors to ascertain information for use as at least part of the context information.

31. The apparatus of claim 29, further comprising one or more position systems to identify an approximate location of the apparatus for use as at least part of the context information.

32. The apparatus of claim 29, wherein any one or more of profile information, user information and device information forms at least part of the context information.

33. The apparatus of claim 22, further comprising a processing system and a life data module executable on the processing system, wherein the processing system is configured to execute the life data module to provide stored data regarding the frequency of occurrence of the identified matching occurrences in a vicinity of the apparatus.

34. The apparatus of claim 22, further comprising a local database, and wherein the transmitting module is configured to transmit the information pertaining to the identified matching occurrences of the external media to the reference media to the local database.

35. A server comprising:
a transmitting module configured to transmit reference media for use by at least one device;
a receiving module configured to receive information pertaining to matching occurrences of the reference media and media obtained by the device;
a database to store at least links; and
a processing system configured to direct the transmitting module to send one or more of the links, identified by the matching occurrences received, for association with the media obtained by the device.

36. The server of claim 35, wherein the database is configured to further store the media obtained by the device that and received via the receiving module.

37. The server of claim 35, wherein the processing system is further configured to modify one or more of the links to be sent based on context information received from the device.

38. The server of claim 35, further comprising a link association module executable by the processing system to associate the links to be sent with the media obtained by the device.

39. A computer-readable medium having instructions stored thereon which are executable by a computing system for identifying occurrences of reference media by performing steps comprising:
storing reference media at a device;
recording media occurring within a vicinity of the device;
comparing the recorded media to the reference media at the device; and
providing information pertaining to matching occurrences of the recorded media and the reference media.

40. A computer-readable medium having instructions stored thereon which are executable by a computing system for facilitating advertising by performing steps comprising:
providing reference media to a device;
receiving information pertaining to matching occurrences of device-recorded media and the reference media; and
in response to receiving the information, providing one or more links for association with the device-recorded media.

41. An apparatus comprising:
means for storing reference media;
means for gathering external media;
means for comparing the external media to the reference media to identify matching occurrences of the external media and the reference media; and
means for providing information pertaining to the identified matching occurrences of the external media and the reference media.
